(19) United States
(12) Patent Application Publication
(10) Pub. No.: US 2017/0253366 A1
(43) Pub. Date: Sep. 7, 2017

(54) SIFT-RESISTANT CONTAINER AND BLANK AND METHOD FOR FORMING THE SAME

(71) Applicant: WestRock Shared Services, LLC, Norcross, GA (US)

(72) Inventors: Jeffrey S. JAMES, Elmhurst, IL (US); Thomas D. GRAHAM, Winter Garden, FL (US); Kenneth C. SMITH, Hiram, GA (US); Timothy MCCARTHY, Chicago, IL (US)

(21) Appl. No.: 15/517,368

(22) PCT Filed: Oct. 9, 2015
(86) PCT No.: PCT/US15/54821

§ 371 Date: Apr. 6, 2017

Related U.S. Application Data
(60) Provisional application No. 62/062,052, filed on Oct. 9, 2014.

(51) Int. Cl. B65D 5/42; B65D 5/46; B65D 5/02

(52) U.S. Cl. CPC B65D 5/4279; B65D 5/0227; B65D 5/46016; B65D 5/029; B65D 5/4266; B65D 5/02; B65D 2525/28; B65D 2525/281; B65D 2525/284; B31B 2201/6017; B65D 5/46

(57) ABSTRACT

A blank for forming a container is provided. The blank includes a plurality of side panels coupled together, the plurality of side panels including at least a first minor panel, and a first intermediate panel extending from a side edge of the first minor panel. The blank also includes a first bottom corner flap extending from a bottom edge of the first intermediate panel, wherein the first bottom corner flap includes a free edge including a first portion, and a first bottom minor flap extending from a bottom edge of the first minor panel, wherein the first bottom minor flap includes a free edge including a first portion. When the container is formed from the blank, the first portion of the free edge of the first bottom corner flap engages the first portion of the free edge of the first bottom minor flap in an edge-to-edge relationship.

### BACKGROUND

This disclosure relates generally to containers formed from blanks of sheet material, and, more specifically, to a blank of sheet material for forming a container, and methods and apparatus for forming the container.

Corrugated board containers are often used to hold granular products (e.g., sugar, flour, or cat litter) or other articles. If the container has a crack or small opening, then some of the product might escape the container by sifting. In order to prevent this, a manufacturer might use additional packaging, such as adding a plastic bag or another kind of insert. The addition of such bags or inserts makes such containers more costly to manufacture and require more attention in making them. For example, such containers may require a more sophisticated type of machine to manufacture them.

### BRIEF DESCRIPTION

In one aspect, a blank for constructing a container is provided. The blank includes a plurality of side panels coupled together in a series along substantially parallel fold lines, the plurality of side panels including at least a first minor panel, and a first intermediate panel extending from a side edge of the first minor panel. The blank also includes a first bottom corner flap extending from a bottom edge of the first intermediate panel, wherein the first bottom corner flap includes a free edge including a first portion, and a first bottom minor flap extending from a bottom edge of the first minor panel, wherein the first bottom minor flap includes a free edge including a first portion. When the container is formed from the blank, the first portion of the free edge of the first bottom corner flap engages the first portion of the free edge of the first bottom minor flap in an edge-to-edge relationship.

In another aspect, a sift-resistant container is provided. The container includes a first side wall, a second side wall extending from a side edge of the first side wall, and a bottom wall. The bottom wall includes a first bottom corner flap extending from a bottom edge of the first side wall, the first bottom corner flap including a free edge including a first portion, and a first bottom minor flap extending from a bottom edge of the second side wall, the first bottom minor flap including a free edge including a first portion. The first portion of the free edge of the first bottom corner flap engages the first portion of the free edge of the first bottom minor flap in an edge-to-edge relationship.

In yet another aspect, a method for forming a sift-resistant container from a blank is provided. The blank includes a plurality of side panels coupled together in a series along substantially parallel fold lines, the plurality of side panels including at least a first minor panel and a first intermediate panel extending from a side edge of the first minor panel. The blank further includes a first bottom corner flap extending from a bottom edge of the first intermediate panel and a first bottom minor flap extending from a bottom edge of the first minor panel, wherein the first bottom corner flap includes a free edge including a first portion and the first bottom minor flap includes a free edge including a first portion. The method includes rotating the plurality of side panels about the plurality of fold lines to form a plurality of side walls of the container, the plurality of side walls defining a cavity, and rotating the first bottom corner flap inwardly towards the cavity into a substantially perpendicular relationship with the plurality of side walls. The method further includes rotating the first bottom minor flap inwardly towards the cavity into a substantially perpendicular relationship with the plurality of side walls, said rotating engaging the first portion of the free edge of the first bottom corner flap with the first portion of the free edge of the first bottom minor flap in an edge-to-edge relationship.

### BRIEF DESCRIPTION OF THE DRAWINGS

FIG. 1 is a top plan view of an interior surface of an example embodiment of a blank of sheet material.

FIG. 2 is an expanded view of a portion of the blank of FIG. 1.

FIG. 3 is a perspective view of an example embodiment of the blank of FIG. 1 illustrating formation of the bottom of a container as the blank is shaped into the container.

FIG. 4 is another perspective view of an example embodiment of the blank of FIG. 1 illustrating formation of the bottom of the container.

FIG. 5 is another perspective view of an example embodiment of the blank of FIG. 1 illustrating formation of a top of the container.

FIG. 6 is another perspective view of an example embodiment of the blank of FIG. 1 illustrating formation of the top of the container.

FIG. 7 is a perspective view of an example embodiment of a container constructed from the blank of FIG. 1.

FIG. 8 is another perspective view of an example embodiment of a container constructed from the blank of FIG. 1.

FIG. 9 is a perspective view of an example embodiment of a handle assembly suitable for use with the blank of FIG. 1.

FIG. 10 is a cross section of an example embodiment of a mandrel used in a machine for forming the container shown in FIG. 8 and illustrating the blank shown in FIG. 1 wrapped partially therearound.

FIG. 11 is a cross section of the mandrel shown in FIG. 10 and illustrating the blank shown in FIG. 1 wrapped partially therearound.

FIG. 12 is another cross section of the mandrel shown in FIG. 10 and illustrating the blank shown in FIG. 1 wrapped partially therearound.

FIG. 13 is a cross section of the mandrel shown in FIG. 10 and illustrating the blank shown in FIG. 1 wrapped therearound.

### DETAILED DESCRIPTION

The following detailed description illustrates the disclosure by way of example and not by way of limitation. The description clearly enables one skilled in the art to make and use the disclosure, describes several embodiments, adaptations, variations, alternatives, and use of the disclosure, including what is presently believed to be the best mode of carrying out the disclosure.

The embodiments described herein provide a sift-resistant container formed from a single sheet of blank material, and a method for constructing the container. The container may be constructed from a blank of sheet material using a machine and/or by hand. In one embodiment, the blank is fabricated from a corrugated cardboard material. The blank, however, may be fabricated using any suitable material, and therefore is not limited to a specific type of material. In alternative embodiments, the blank is fabricated using cardboard, plastic, fiberboard, paperboard, foamboard, corrugated paper, and/or any suitable material known to those skilled in the art and guided by the teachings herein provided.

In one embodiment, the blank includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to including, ink jet printing, laser printing, screen printing, giclée, pen and ink, painting, offset lithography, flexography, relief print, rotogravure, dye transfer, and/or any suitable printing technique known to those skilled in the art and guided by the teachings herein provided. In another embodiment, the blank is void of markings, such as, without limitation, indicia that communicates the product, a manufacturer of the product and/or a seller of the product.

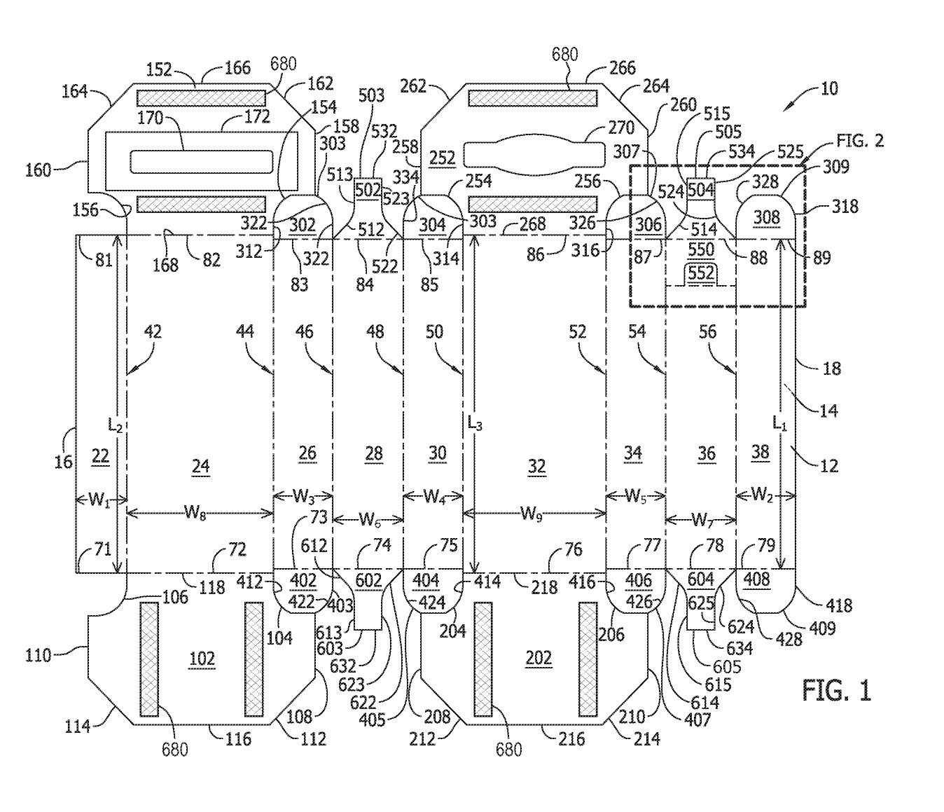

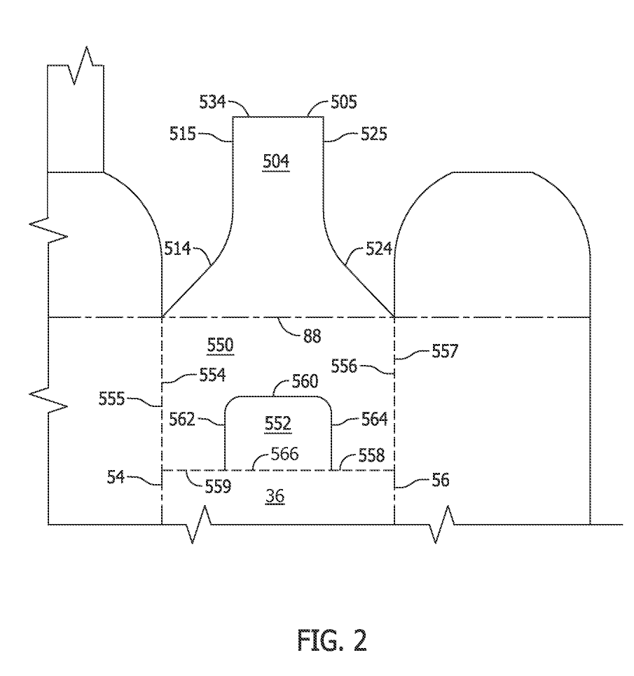

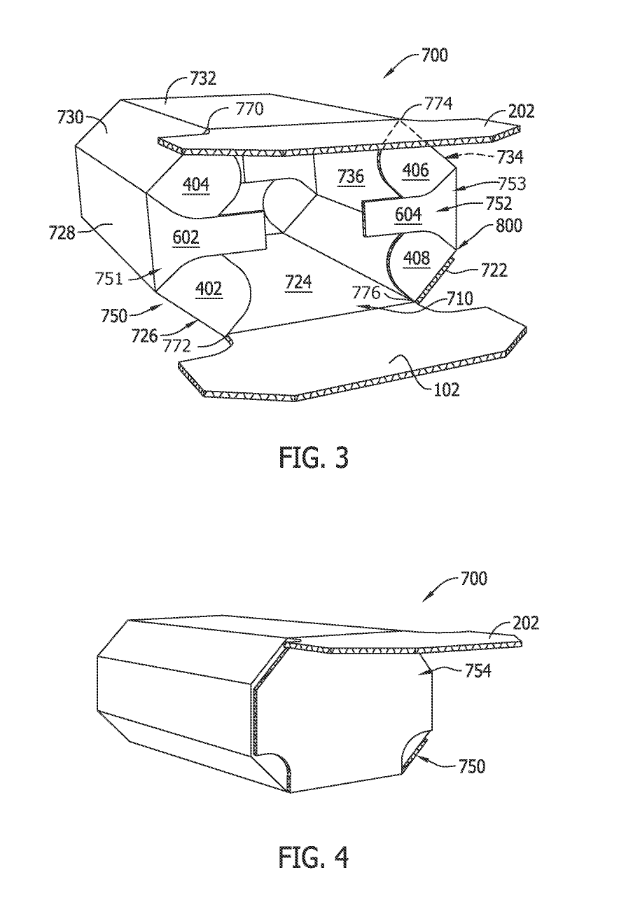

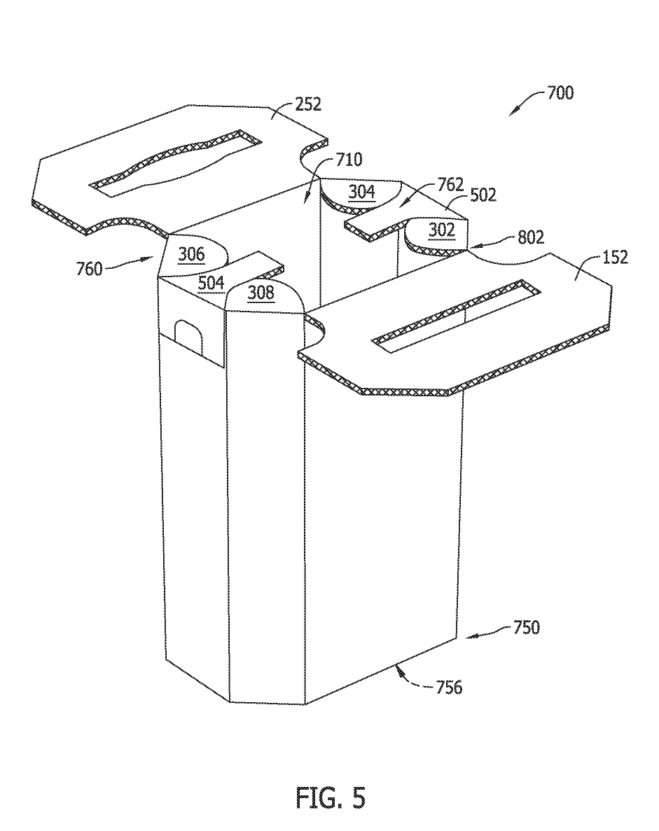

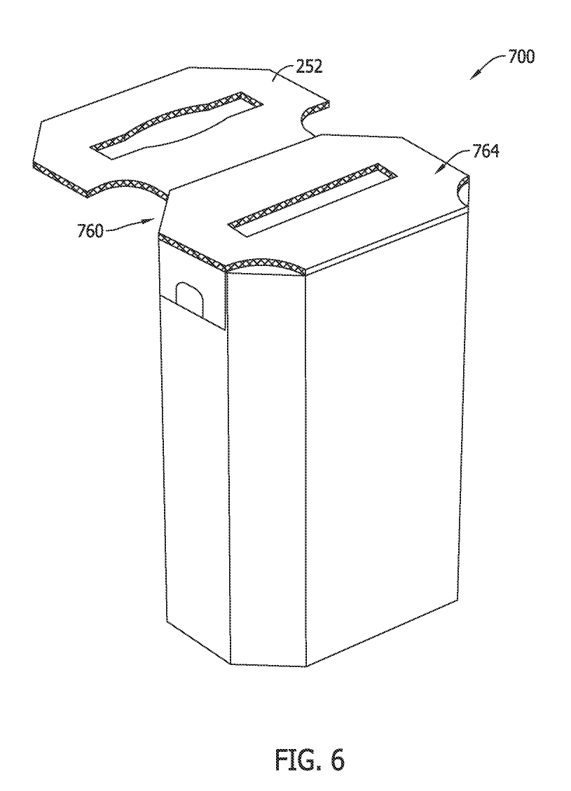

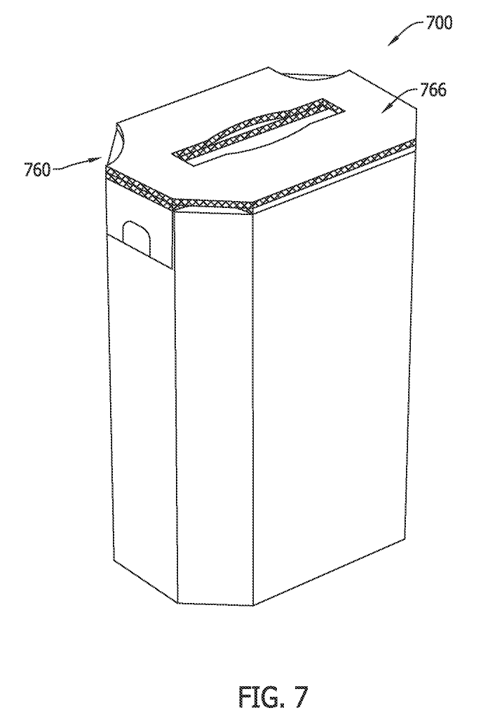

FIGS. 1-7 illustrate the formation of one embodiment of a container 700 (shown in particular in FIG. 7). As shown in FIG. 1, a blank of sheet material for forming container 700 is designated in its entirety by the reference numeral 10. FIG. 2 is an expanded view of a portion of blank 10. FIGS. 3 and 4 are perspective views of blank 10 illustrating formation of the bottom of container 700 as blank 10 is shaped into container 700. FIGS. 5 and 6 are perspective views of blank 10 illustrating formation of a top of container 700. FIG. 7 is a perspective view of container 700 constructed from blank 10.

Blank 10 has a first or interior surface 12 and an opposing second or exterior surface 14. Further, blank 10 defines a leading edge 16 and an opposing trailing edge 18. In one embodiment, blank 10 includes, in series from leading edge 16 to trailing edge 18, a plurality of panels including a first end panel 22, a first major panel 24, a first intermediate panel 26, a first minor panel 28, a second intermediate panel 30, a second major panel 32, a third intermediate panel 34, a second minor panel 36, and a second end panel 38. Panels 22, 24, 26, 28, 30, 32, 34, 36, 38 are coupled together by a plurality of generally parallel fold lines 42, 44, 46, 48, 50, 52, 54, 56, respectively. In one embodiment, fold lines 42, 44, 46, 48, 50, 52, 54, 56 are preformed. In the example embodiment, each of panels 22, 24, 26, 28, 30, 32, 34, 36, and 38 is substantially rectangular. In other embodiments, any of panels 22, 24, 26, 28, 30, 32, 34, 36, and/or 38 may have any size, shape and/or configuration that enables blank 10 and container 700 to function as described herein.

As shown in FIG. 1, second end panel 38 extends from second minor panel 36 along fold line 56; second minor panel 36 extends from third intermediate panel 34 along fold line 54; third intermediate panel 34 extends from second major panel 32 along fold line 52; second major panel 32 extends from second intermediate panel 30 along fold line 50; second intermediate panel 30 extends from first minor panel 28 along fold line 48; first minor panel 28 extends from first intermediate panel 26 along fold line 46; first intermediate panel 26 extends from first major panel 24 along fold line 44; and first major panel 24 extends from first end panel 22 along fold line 42.

First end panel 22 has a width W₁. Second end panel 38 has a width W₂. Similarly, first intermediate panel 26 has a width W₃; second intermediate panel 30 has a width W₄; and third intermediate panel 34 has a width W₅. In the embodiment shown in FIG. 1, widths W₁, W₂, W₃, W₄, and W₅ are substantially equal. In alternative embodiments, any of widths W₁, W₂, W₃, W₄, and W₅ may be other than substantially equal to any other of widths W₁, W₂, W₃, W₄, and/or W₅ without departing from the scope of the present disclosure. Additionally, each minor panel 28, 36 has a respective width W₆, W₇. In the example embodiment, widths W₆ and W₇ are substantially equal. In alternate embodiments, widths W₆ and W₇ may be other than substantially equal. Further, each major panel 24, 32 has a respective width W₈ and W₉. In the example embodiment, widths W₈ and W₉ are substantially equal. In alternate embodiments, widths W₈ and W₉ may be other than substantially equal.

Furthermore, each panel 22, 24, 26, 28, 30, 32, 34, 36, 38 has a top edge 81, 82, 83, 84, 85, 86, 87, 88, 89, respectively. Top edges 81, 82, 83, 84, 85, 86, 87, 88, 89 are generally perpendicular to respective fold lines 42, 44, 46, 48, 50, 52, 54, and/or 56. Likewise, each panel 22, 24, 26, 28, 30, 32, 34, 36, 38 has a bottom edge 71, 72, 73, 74, 75, 76, 78, and 79, respectively. Bottom edges 71, 72, 73, 74, 75, 76, 78, and 79 are generally perpendicular to fold lines 42, 44, 46, 48, 50, 52, 54, and/or 56.

In the example embodiment, first intermediate panel 26, first minor panel 28, second intermediate panel 30, third intermediate panel 34, second minor panel 36, and second end panel 38 have a length L₁ measured from bottom edge 79 to top edge 89 of second end panel 38. First end panel 22 and first major panel 24 have a length L₂ measured from bottom edge 71 to top edge 81 of first end panel 22. Second major panel 32 has a length L₃ measured from bottom edge 76 to top edge 86 of second major panel 32. In the example embodiment, L₂ is slightly longer than L₁, extending a distance approximately equal to a thickness of the material of blank 10 further than L₁ at both top edge 81 and bottom edge 71, such that L₂ is longer than L₁ by a total of twice the thickness of the material of blank 10 (i.e., with the extra length disposed evenly at the ends of first end panel 22 and first major panel 24). L₃ is slightly longer than L₂, extending a distance approximately equal to the thickness of the material of blank 10 further than L₂ at both top edge 86 and bottom edge 76, such that L₃ is longer than L₁ by a total of twice the thickness of the material of blank 10 (i.e., with the extra length disposed evenly at the ends of second major panel 32). In other words, L₃ is slightly longer than L₁, by a length approximately equal to four times the thickness of the material of blank 10. As is described below, this facilitates reducing gaps in a bottom of a constructed container by accommodating for the blank thickness.

A first bottom major flap 102 extends from first major panel 24 along a fold line at bottom edge 72. In the illustrated embodiment, first bottom major flap 102 has side edges 104, 106, 108, 110, 112, 114, 116, and 118. Side edge 104 extends from fold line 44, and side edge 106 extends from fold line 42. In the example embodiment, a length of side edges 116, 118 is substantially equal to width W₈ of first major panel 24. In addition, a length of side edge 108 is substantially equal to width W₆ of first minor panel 28, and a length of side edge 110 is substantially equal to width W₇ of second minor panel 36. Moreover, side edges 104, 106 define, respectively, a first and a second concave arcuate side edge of first bottom major flap 102.

A second bottom major flap 202 extends from second major panel 32 along a fold line at bottom edge 76. In the illustrated embodiment, second bottom major flap 202 has side edges 204, 206, 208, 210, 212, 214, 216, and 218. Side edge 204 extends from fold line 50, and side edge 206 extends from fold line 52. In the example embodiment, a length of side edges 216, 218 is substantially equal to width W₉ of second major panel 32. In addition, a length of side edge 208 is substantially equal to width W₆ of first minor panel 28, and a length of side edge 210 is substantially equal to width W₇ of second minor panel 36. Moreover, side edges 204, 206 define, respectively, a first and a second concave arcuate side edge of second major bottom flap 202.

A first top major flap 152 extends from first major panel 24 along a fold line at top edge 82, opposite first bottom major flap 102. In the illustrated embodiment, first top major flap 152 has side edges 154, 156, 158, 160, 162, 164, 166, and 168. Side edge 154 extends from fold line 44, and side edge 156 extends from fold line 42. In the example embodiment, a length of side edges 166, 168 are substantially equal to width W₈ of first major panel 24. In addition, a length of side edge 158 is substantially equal to width W₆ of first minor panel 28, and a length of side edge 160 is substantially equal to width W₇ of second minor panel 36. Side edges 154, 156 define, respectively a first and a second concave arcuate side edge of first top major flap 152.

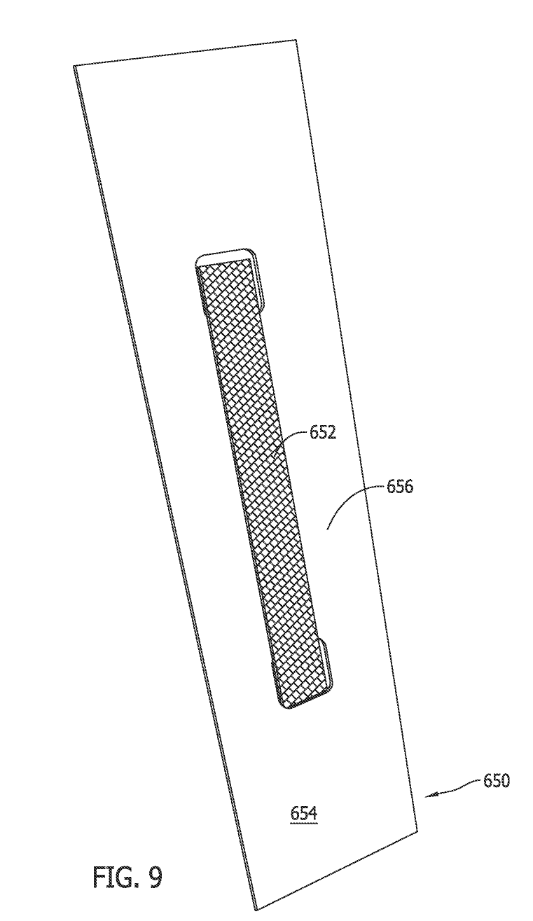

First top major flap 152 further includes an inner handle cutout 170. With reference to FIGS. 1 and 9, inner handle cutout 170 is configured to retain a handle 652 during assembly, storage, display, and use of container 700. A handle attachment region 172 is configured for attachment of a handle assembly 650 that includes handle 652 during assembly of container 700. Handle assembly 650 includes an adhesive region 654 to which adhesive (not shown) is applied to facilitate the attachment of handle assembly 650 to container 700. Handle 652 is releasably coupled against a backing 656 of handle assembly 650 during assembly, storage, and display of container 700. Handle 652 is decoupled from backing 656 upon application of a pulling force by a consumer, enabling transport of container 700 at handle 652.

A second top major flap 252 extends from second major panel 32 along a fold line at top edge 86, opposite second bottom major flap 202. In the illustrated embodiment, second top major flap 252 has side edges 254, 256, 258, 260, 262, 264, 266, and 268. Side edge 254 extends from fold line 50, and side edge 256 extends from fold line 52. In the example embodiment, a length of side edges 266, 268 is substantially equal to width W₉ of second major panel 32. In addition, a length of side edge 258 is substantially equal to width W₆ of first minor panel 28, and a length of side edge 260 is substantially equal to width W₇ of second minor panel 36. Side edges 254, 256 define, respectively a first and a second concave arcuate side edge of second top major flap 252. Second top major flap 252 further includes an outer handle cutout 270. Outer handle cutout 270 is configured to retain handle 652 during assembly, storage, display, and use of container 700.

In the illustrated embodiment, blank 10 further includes a plurality of minor tabs, each extending from a respective edge of the plurality of panels. More specifically, a first top corner flap 302 extends from a fold line along top edge 83 of first intermediate panel 26; a second top corner flap 304 extends from a fold line along top edge 85 of second intermediate panel 30; a third top corner flap 306 extends from a fold line along top edge 87 of third intermediate panel 34; and a fourth top corner flap 308 extends from a fold line along top edge 89 of end panel 38. A first bottom corner flap 402 extends from a fold line along bottom edge 73 of first intermediate panel 26; a second bottom corner flap 404 extends from a fold line along bottom edge 75 of second intermediate panel 30; a third bottom corner flap 406 extends from a fold line along bottom edge 77 of third intermediate panel 34; and a fourth bottom corner flap 408 extends from a fold line along bottom edge 79 of end panel 38.

Each corner flap 302, 304, 306, 308, 402, 404, 406, 408 includes a free edge, 303, 305, 307, 309, 403, 405, 407, 409 respectively, defining a perimeter of corner flap 302, 304, 306, 308, 402, 404, 406, 408. As shown in FIG. 1, free edge 303 includes a first arcuate convex portion 312 and a second arcuate convex portion 322. Similarly, each of outer edges 305, 307, 309, 403, 405, 407, 409 has a respective first arcuate convex portion 314, 316, 318, 412, 414, 416, 418 and a respective second arcuate convex portion 322, 324, 326, 328, 422, 424, 426, 428.

Each of first arcuate convex portions 312, 314, 316, 318, 412, 414, 416, 418 has a shape (e.g., an arc) complementary to the shape (e.g., an arc) of, respectively, concave arcuate side edges 154, 254, 256, 156, 104, 204, 206, 106 of first top major flap 152, second top major flap 252, first bottom major flap 102, and second bottom major flap 202. Although arcs defined by arcuate convex portions 312, 314, 316, 412, 414, 416 are illustrated as complementary to arcs defined by side edges 154, 254, 256, 104, 204, 206 in the example embodiment, it is apparent to those skilled in the art and guided by the teachings provided herein that non-complementary arcs or other non-arcuate shapes may be used for other embodiments of the present disclosure.

The plurality of minor tabs of blank 10 further includes a first top minor flap 502 that extends from a fold line along top edge 84 of first minor panel 28, and a second top minor flap 504 that extends from a fold line along top edge 88 of second minor panel 36, as well as a first bottom minor flap 602 that extends from a fold line along bottom edge 74 of first minor panel 28, and a second bottom minor flap 604 that extends from a fold line along bottom edge 78 of second minor panel 36.

Each of minor flaps 502, 504, 602, 604 includes a free edge 503, 505, 603, 605, respectively. Free edge 503 of first top minor flap 502 includes a first arcuate concave portion 512, a second arcuate concave portion 522, and an end edge 532. Likewise, each of free edges 505, 603, 605 includes a first arcuate concave portion 514, 612, 614, respectively, a second arcuate concave portion 524, 622, 624, respectively, and an end edge 534, 632, 634, respectively. End edges 532, 534, 632, 634 are substantially perpendicular to fold lines 42, 44, 46, 48, 50, 52, 54, 56. In some embodiments, end edges 532, 534, 632, 634 may be other than substantially perpendicular to fold lines 42, 44, 46, 48, 50, 52, 54, 56.

First arcuate concave portion 512 of first top minor flap 502 has a shape (e.g., an arc) complementary to a shape (e.g., an arc) of second arcuate convex portion 322 of first top corner flap 302. Second arcuate concave portion 522 of first top minor flap 502 has a shape (e.g., an arc) complementary to a shape (e.g., an arc) of second arcuate convex portion 324 of second top corner flap 304. Likewise, first arcuate concave portion 514 of second top minor flap 504 has a shape (e.g., an arc) complementary to a shape (e.g., an arc) of second arcuate convex portion 326 of third top corner flap 306. Second arcuate concave portion 524 of second top minor flap 504 has a shape (e.g., an arc) complementary to a shape (e.g., an arc) of second arcuate convex portion 328 of fourth top corner flap 308.

In the same manner, first arcuate concave portion 612 of first bottom minor flap 602 has a shape (e.g., an arc) complementary to a shape (e.g., an arc) of second arcuate convex portion 422 of first bottom corner flap 402. Second arcuate concave portion 622 of first bottom minor flap 602 has a shape (e.g., an arc) complementary to a shape (e.g., an arc) of second arcuate convex portion 424 of second bottom corner flap 404. Likewise, first arcuate concave portion 614 of second bottom minor flap 604 has a shape (e.g., an arc) complementary to a shape (e.g., an arc) of second arcuate convex portion 426 of third bottom corner flap 406. Second arcuate concave portion 624 of second bottom minor flap 604 has a shape (e.g., an arc) complementary to a shape (e.g., an arc) of second arcuate convex portion 428 of fourth bottom corner flap 408.

In the illustrated embodiment, free edge 503 of first top minor flap 502 further includes first extension portion 513 and second extension portion 523. First extension portion 513 extends from first arcuate concave portion 512 to end edge 532, and second extension portion 523 extends from end edge 532 to second arcuate concave portion 522. Arcuate concave portions 512, 522, extension portions 513, 523, and end edge 532 define a surface area of first top minor flap 502 to which adhesive or any other suitable sealant may be applied when container 700 is formed from blank 10. In alternative embodiments, extension portions 513, 523 may be omitted from first top minor flap 502, wherein arcuate concave portions 512, 522 and end edge 532 define a reduced surface area of first top minor flap 502.

In the illustrated embodiment, as also shown in FIG. 2, free edge 505 of second top minor flap 504 further includes first extension portion 515 and second extension portion 525. First extension portion 515 extends from first arcuate concave portion 514 to end edge 534, and second extension portion 525 extends from end edge 534 to second arcuate concave portion 524. Arcuate concave portions 514, 524, extension portions 515, 525, and end edge 534 define a surface area of second top minor flap 504 to which adhesive or any other suitable sealant may be applied when container 700 is formed from blank 10. In alternative embodiments, extension portions 515, 525 may be omitted from second top minor flap 504, wherein arcuate concave portions 514, 524 and end edge 534 define a reduced surface area of second top minor flap 504.

In the illustrated embodiment, free edge 603 of first bottom minor flap 602 further includes first extension portion 613 and second extension portion 623. First extension portion 613 extends from first arcuate concave portion 612 to end edge 632, and second extension portion 623 extends from end edge 632 to second arcuate concave portion 622. Arcuate concave portions 612, 622, extension portions 613, 623, and end edge 632 define a surface area of first bottom minor flap 602 to which adhesive or any other suitable sealant may be applied when container 700 is formed from blank 10. In alternative embodiments, extension portions 613, 623 may be omitted from first bottom minor flap 602, wherein arcuate concave portions 612, 622 and end edge 632 define a reduced surface area of first bottom minor flap 602.

In the illustrated embodiment, free edge 605 of second bottom minor flap 604 further includes first extension portion 615 and second extension portion 625. First extension portion 615 extends from first arcuate concave portion 614 to end edge 634, and second extension portion 625 extends from end edge 634 to second arcuate concave portion 624. Arcuate concave portions 614, 624, extension portions 615, 625, and end edge 634 define a surface area of second bottom minor flap 604 to which adhesive or any other suitable sealant may be applied when container 700 is formed from blank 10. In alternative embodiments, extension portions 615, 625 may be omitted from second bottom minor flap 604, wherein arcuate concave portions 614, 624 and end edge 634 define a reduced surface area of second bottom minor flap 604.

In the illustrated embodiment, as shown in FIGS. 3 and 5 with respect to forming container 700 from blank 10, the shapes of first arcuate concave portions 612, 614 are complementary to the shapes of second arcuate convex portions 422, 426, respectively; and the shapes of second arcuate concave portions 622, 624 are complementary to the shapes of second arcuate convex portion 424, 428, respectively, such that bottom corner flaps 402, 404, 406, 408 engage with bottom minor flaps 602, 604 to facilitate reducing gaps at the bottom 750 of container 700. Similarly, in the illustrated embodiment, the shapes of first arcuate concave portions 512, 514 are complementary to the shapes of second arcuate convex portions 322, 326, respectively; and the shapes of second arcuate concave portions 522, 524 are complementary to the shapes of second arcuate convex portion 324, 328, respectively, such that top corner flaps 302, 304, 306, 308 engage with top minor flaps 502, 504 to facilitate reducing gaps at the top 760 of container 700.

It is apparent to those skilled in the art and guided by the teachings herein provided that other shapes for the respective free edges of minor tabs 302, 304, 306, 308, 402, 404, 406, 408, 502, 504, 602, and/or 604 may be suitable to perform as described herein, as long as the shape(s) of the free edge(s) of each minor tab is complementary to the shape(s) of the free edge(s) of respective adjacent minor tabs.

Referring now to FIG. 2, in the illustrated embodiment, second top minor flap 504 further includes an access tab 550 that extends from the fold line at top edge 88 into second minor panel 36. Access tab 550 includes a first side edge 554 and an opposing second side edge 556. Access tab 550 further includes a third side edge 558 opposite the fold line along top edge 88. First side edge 554 defines a first side portion 555 of second minor panel 36 along fold line 54, second side edge 556 defines a second side portion 557 of second minor panel 36 along fold line 56, and third side edge 558 defines an intermediate edge 559 of second minor panel 36 substantially perpendicular to first and second side portions 555, 557. Each of first side edge 554, second side edge 556, and third side edge 558 is generally formed as a line of weakness. As used herein, the term “line of weakness” refers to any preformed line, such as but not limited to score lines, perforation lines, or lines of separation, along which the blank material is configured to have a relatively decreased resistance to folding or tearing.

Access tab 550 further includes a punch-out tab 552. A perimeter of punch-out tab 552 is defined by a fold line 560, a first side edge 562, an opposing second side edge 564, and a third side edge 566 opposite fold line 560. Third side edge 566 defines a portion of third side edge 558 of access tab 550. Each of first side edge 562, second side edge 564, and third side edge 566 is generally formed as a line of weakness.

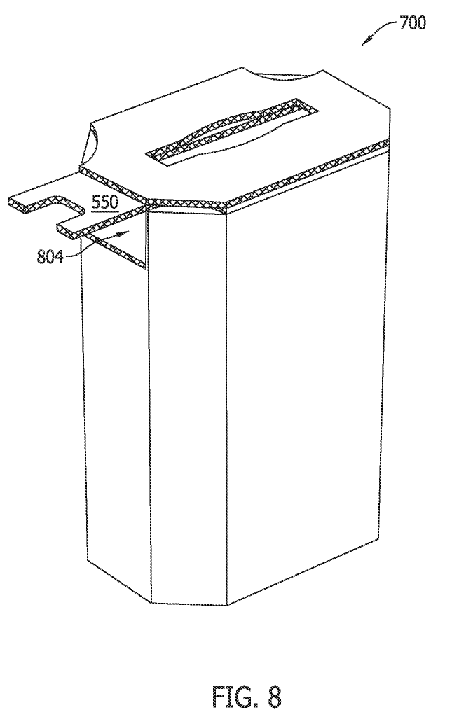

A consumer may open container 700 (e.g., access a cavity 710 defined therein) by applying a pushing force to the exterior surface 14 punch-out tab 552. Punch-out tab 552 decouples from access tab 550 along side edges 562, 564, 566 and rotates about fold line 560 into cavity 710 through an opening (not shown) defined by the perimeter of punch-out tab 552. The consumer is then able to contact interior surface 12 of access tab 550. The consumer applies a pulling force to access tab 550, such that access tab 550 decouples from second minor panel 36 along side edges 554, 556, and 558. Access tab 550 rotates about the fold line at top edge 88. First side portion 555 of second minor panel 36, second side portion 557 of second minor panel 36, intermediate edge 559 of second minor panel 36, and top edge 88 define an access opening 804 (shown in FIG. 8) to cavity 710 of container 700. Accordingly, in such an embodiment, second minor top flap 504 may be removed from container 700 when the consumer opens container 700 as described above. In other words, after the consumer decouples access tab 550 from container 700, the consumer may fully withdraw or remove second minor top flap 504 from container 700. Additionally or alternatively, an access tab similar to access tab 500 may extend from first minor top flap 502 into first minor panel 28 and function substantially identically as described with respect to access tab 550

In some embodiments, adhesive is applied to blank 10 in one or more adhesive regions 680, as shown in FIG. 1, such that container 700 may be formed from blank 10. Adhesive may be applied in adhesive regions 680 in strips, beads, dots, sheets, or in any other suitable manner. Additionally, adhesive need not be applied to an entirety of any adhesive region 680 but may be applied to only a portion of one or more adhesive regions 680. Alternatively, adhesive may applied to a greater portion of blank 10 than as indicated by adhesive regions 680. Moreover, adhesive and/or adhesive regions may be otherwise arranged or applied than as shown in FIG. 1.

As will be described below in more detail with further reference to FIGS. 3-7, blank 10 is intended to form container 700 as shown in FIG. 7 by wrapping, coupling, and/or securing panels 22, 24, 26, 28, 30, 32, 34, 36, 38, minor tabs 302, 304, 306, 308, 402, 404, 406, 408, 502, 504, 602, 604, bottom major flaps 102, 202, and top major flaps 152, 252. In one embodiment, the panels and flaps are wrapped, coupled, and/or secured in order to reduce gaps in a container. Furthermore, it is apparent that those skilled in the art and from the teachings provided herein that blanks may have any suitable shape, size, and/or configuration that enables container 700 to perform as described herein.

In the example embodiment, when container 700 is formed from blank 10, the panels of blank 10 are rotated toward interior surface 12 such that end panels 22, 38 at least partially overlap each other. End panels 22, 38 are coupled or secured to each other using a suitable coupling or securing mechanism, such as an adhesive material. It is apparent to those skilled in the art and guided by the teachings herein provided that any suitable coupling or securing mechanism may be used to couple or secure end panels 22, 38. In one embodiment, as shown in FIGS. 3-8, end panel 38 overlaps end panel 22. In an alternative embodiment, end panel 22 overlaps end panel 38.

Panels 24, 26, 28, 30, 32, 34, 36 and overlapping coupled or secured end panels 22, 38 of blank 10 define side walls 724, 726, 728, 730, 732, 734, 736, and 722, respectively. In the illustrated embodiment, side walls 722, 724, 726, 728, 730, 732, 734, 736 are obliquely angled relative to adjacent side walls. In one embodiment, side walls 722, 724, 726, 728, 730, 732, 734, 736 are angled at about 135° with respect to adjacent side walls. However, it is apparent to those skilled in the art and guided by the teachings provided herein that other angles may be used for other embodiments of the present disclosure.

A cavity 710 (or void 710) is defined as the space circumscribed by side walls 724, 726, 728, 730, 732, 734, 736, 722. Cavity 710 has a top and a bottom. First bottom major flap 102 is rotated inwardly, that is, towards cavity 710, such that first bottom major flap 102 is substantially perpendicular to panel 36 and at least partially covers the bottom of cavity 710. First top major flap 152 is rotated inwardly such that first top major flap 152 is substantially perpendicular to panel 36 and at least partially covers the top of cavity 710.

As shown in FIG. 3, to construct a bottom 750 of container 700, after end panels 22, 38 are secured to form cavity 710, as described above-bottom corner flaps 402, 404, 406, 408 are rotated inwardly about respective fold lines into a substantially perpendicular relationship with side walls 722, 724, 726, 728, 730, 732, 734, 736. In addition, bottom minor flaps 602, 604 are rotated inwardly about respective fold lines into a substantially perpendicular relationship with side walls 722, 724, 726, 728, 730, 732, 734, 736. Accordingly, bottom corner flaps 402, 404, 406, 408 are substantially coplanar with bottom minor flaps 602, 604 in a plane 800 that is substantially perpendicular to side walls 722, 724, 726, 728, 730, 732, 734, 736. Bottom corner flaps 402, 404, 406, 408 and bottom minor flaps 602, 604 define a substantially flat inner layer 752 of bottom 750 of container 700. Inner layer 752 at least partially covers cavity 710.

More particularly, inner layer 752 includes a first region 751, defined by bottom corner flaps 402 and 404 and first bottom minor flap 602. The complementary shapes of bottom corner flaps 402, 404 and first bottom minor flap 602 prevents gaps or openings in first region 751, preventing the loss of product from container 700 along first region 751. At least a portion of second arcuate convex portion 422 of free edge 403 of first bottom corner flap 402 engages with at least a portion of first arcuate concave portion 612 of free edge 603 of first bottom minor panel 602 in a non-overlapping, gapless, and/or edge-to-edge relationship. In the example embodiment, the entire second arcuate convex portion 422 of free edge 403 of first bottom corner flap 402 engages with the entire first arcuate concave portion 612 of free edge 603 of first bottom minor panel 602 in a non-overlapping, gapless, and/or edge-to-edge relationship.

Similarly, at least a portion of second arcuate convex portion 424 of free edge 405 of second bottom corner panel 404 engages with at least a portion of second arcuate concave portion 622 of free edge 603 of first bottom minor panel 602 in a non-overlapping, gapless, and/or edge-to-edge relationship. In the example embodiment, the entire second arcuate convex portion 424 of free edge 405 of second bottom corner panel 404 engages with the entire second arcuate concave portion 622 of free edge 603 of first bottom minor panel 602 in a non-overlapping, gapless, and/or edge-to-edge relationship. Accordingly, first region 751 of inner layer 752 is has a planar and substantially continuous area extending from a first corner 770 defined between side wall 732 and side wall 730 and a second corner 772 defined between side wall 724 and side wall 726, to the bottom edges of side walls 730, 728, and 726.

Inner layer 752 further includes a second region 753, defined by bottom corner flaps 406 and 408 and second bottom minor flap 604. The complementary shapes of bottom corner flaps 406 and 408 and second bottom minor flap 604 prevents gaps or openings in second region 753, preventing the loss of product from container 700 along second region 753.

At least a portion of second arcuate convex portion 426 of free edge 407 of third bottom corner flap 406 engages with at least a portion of first arcuate concave portion 614 of free edge 605 of second bottom minor panel 604 in a non-overlapping, gapless, and/or edge-to-edge relationship. In the example embodiment, the entire second arcuate convex portion 426 of free edge 407 of third bottom corner flap 406 engages with the entire first arcuate concave portion 614 of free edge 605 of second bottom minor panel 604 in a non-overlapping, gapless, and/or edge-to-edge relationship.

Similarly, at least a portion of second arcuate convex portion 428 of free edge 409 of third bottom corner flap 408 engages with at least a portion of second arcuate concave portion 624 of free edge 605 of second bottom minor panel 604 in a non-overlapping, gapless, and/or edge-to-edge relationship. In the example embodiment, the entire second arcuate convex portion 428 of free edge 409 of third bottom corner flap 408 engages with the entire second arcuate concave portion 624 of free edge 605 of second bottom minor panel 604 in a non-overlapping, gapless, and/or edge-to-edge relationship. Accordingly, second region 752 of inner layer 752 is has a planar and substantially continuous area extending from a first corner 774 defined between side wall 732 and side wall 734 and a second corner 776 defined between side wall 724 and side wall 722, to the bottom edges of side walls 722, 736, and 734.

First bottom major flap 102 is rotated toward interior surface 12 of first major panel 24 (side wall 724) into a face-to-face relationship with inner layer 752, such that first bottom major flap 102 defines an intermediate layer 754 of bottom 750 of container 700. Intermediate layer 754 at least partially covers inner layer 752 and cavity 710. In the example embodiment, first bottom major flap 102, defining intermediate layer 754, covers cut lines or seams in first region 751 of inner layer 752, between first bottom corner flap 402 and first bottom minor panel 602, and between second bottom corner flap 404 and first bottom minor panel 602, to enhance the sift-resistance of container 700. Similarly, first bottom major flap 102, defining intermediate layer 754, covers cut lines or seams in second region 753 of inner layer 752, between third bottom corner flap 406 and second bottom minor panel 604, and between fourth bottom corner flap 408 and second bottom minor panel 604, to enhance the sift-resistance of container 700. In one embodiment, first bottom major flap 102 is coupled or secured to inner layer 752 by an adhesive material. In alternative embodiments, any suitable coupling material and/or mechanism may be used to couple or secure first bottom major flap 102 to inner layer 752. In the example embodiment, because length L₂ of first major panel 24 (side wall 724) is longer than length L₁ (described above), first bottom major flap 102 couples snugly against inner layer 752 without deformation of either first bottom major flap 102 or inner layer 752. Accordingly, intermediate layer 754 maintains inner layer 752 in a planar orientation, such that no gaps are formed in the corners between side wall 724, inner layer 752, and intermediate layer 754, further preventing the loss of product from container 700.

Second bottom major flap 202 is rotated toward interior surface 12 of second major panel 32 (side wall 732) into a face-to-face relationship with intermediate layer 754, such that second bottom major flap 202 defines an outer layer 756 of bottom 750 of container 700. Outer layer 756 at least partially covers intermediate layer 754. In one embodiment, second bottom major flap 202 is coupled or secured to intermediate layer 754 by an adhesive material. In alternative embodiments, any suitable coupling material and/or mechanism may be used to couple or secure second bottom major flap 202 to intermediate layer 754. In the example embodiment, because length L₃ of second major panel 32 (side wall 732) is longer than length L₂ (described above), second bottom major flap 202 couples snugly against intermediate layer 754 without deformation of either second bottom major flap 202, intermediate layer 754, or inner layer 752. Accordingly, outer layer 756 maintains intermediate layer 754 in a planar orientation, such that no gaps are formed in the corners between side wall 732, intermediate layer 754, and outer layer 756 further preventing the loss of product from container 700.

With reference to FIG. 5, to construct a top 760 of container 700, top corner flaps 302, 304, 306, 308 are rotated inwardly about respective fold lines into a substantially perpendicular relationship with side walls 722, 724, 726, 728, 730, 732, 734, 736. In addition, top minor flaps 502, 504 are rotated inwardly about respective fold lines into a substantially perpendicular relationship with side walls 722, 724, 726, 728, 730, 732, 734, 736. Accordingly, top corner flaps 302, 304, 306, 308 are substantially coplanar with top minor flaps 502, 504 in a plane 802 that is substantially perpendicular to side walls 722, 724, 726, 728, 730, 732, 734, 736. Top corner flaps 302, 304, 306, 308 and top minor flaps 502, 504 define a substantially flat inner layer 762 of top 760 of container 700. Inner layer 762 at least partially covers cavity 710.

At least a portion of second arcuate convex portion 322 of free edge 303 of first top corner flap 302 engages with at least a portion of first arcuate concave portion 512 of free edge 503 of first top minor panel 502 in a non-overlapping, gapless, and/or face-to-face relationship. In the example embodiment, the entire second arcuate convex portion 322 of free edge 303 of first top corner flap 302 engages with the entire first arcuate concave portion 512 of free edge 503 of first top minor panel 502 in a non-overlapping, gapless, and/or face-to-face relationship.

Similarly, at least a portion of second arcuate convex portion 324 of free edge 305 of second top corner panel 304 engages with at least a portion of second arcuate concave portion 522 of free edge 503 of first top minor panel 502 in a non-overlapping, gapless, and/or face-to-face relationship. In the example embodiment, the entire second arcuate convex portion 324 of free edge 305 of second top corner panel 304 engages with the entire second arcuate concave portion 522 of free edge 503 of first top minor panel 502 in a non-overlapping, gapless, and/or face-to-face relationship.

At least a portion of second arcuate convex portion 326 of free edge 307 of third top corner flap 306 engages with at least a portion of first arcuate concave portion 514 of free edge 505 of second top minor panel 504 in a non-overlapping, gapless, and/or face-to-face relationship. In the example embodiment, the entire second arcuate convex portion 326 of free edge 307 of third top corner flap 306 engages with the entire first arcuate concave portion 514 of free edge 505 of second top minor panel 504 in a non-overlapping, gapless, and/or face-to-face relationship.

Similarly, at least a portion of second arcuate convex portion 328 of free edge 309 of third top corner flap 308 engages with at least a portion of second arcuate concave portion 524 of free edge 505 of second top minor panel 604 in a non-overlapping, gapless, and/or face-to-face relationship. In the example embodiment, the entire second arcuate convex portion 328 of free edge 309 of third top corner flap 308 engages with the entire second arcuate concave portion 524 of free edge 505 of second top minor panel 604 in a non-overlapping, gapless, and/or face-to-face relationship.

First top major flap 152 is rotated toward interior surface 12 of first major panel 24 (side wall 724) into a face-to-face relationship with inner layer 762, such that first top major flap 152 defines an intermediate layer 764 of top 760 of container 700. Intermediate layer 764 at least partially covers inner layer 762 and cavity 710. In one embodiment, first top major flap 152 is coupled or secured to inner layer 762 by an adhesive material. In alternative embodiments, any suitable coupling material and/or mechanism may be used to couple or secure first top major flap 152 to inner layer 762. Second top major flap 252 is rotated toward interior surface 12 of second major panel 32 (side wall 732) into a face-to-face relationship with intermediate layer 764, such that second top major flap 252 defines an outer layer 766 of top 760. Outer layer 766 at least partially covers intermediate layer 764. In one embodiment, second top major flap 252 is coupled or secured to intermediate layer 764 by an adhesive material. In alternative embodiments, any suitable coupling material and/or mechanism may be used to couple or secure second top major flap 252 to intermediate layer 764.

A method for constructing container 700 from a blank, such as blank 10 described above, is also provided. In one embodiment, the method includes providing blank 10 having panels 22, 24, 26, 28, 30, 32, 34, 36, 38 coupled together in a series along corresponding, generally parallel, fold lines 42, 44, 46, 48, 50, 52, 54, 56. First end panel 22 is coupled to second end panel 38 to form a plurality of side walls 722, 724, 726, 728, 730, 732, 734, 736 defining a cavity 710 within.

Bottom minor tabs 402, 404, 406, 408, 602, 604 are rotated about respective fold lines at bottom edges 73, 75, 77, 79, 74, 78 such that the plurality of bottom minor tabs 402, 404, 406, 408, 602, 604 are substantially coplanar in bottom plane 800 substantially perpendicular to the plurality of side walls 722, 724, 726, 728, 730, 732, 734, 736, the plurality of bottom minor tabs 402, 404, 406, 408, 602, 604 defining inner layer 752 of bottom 750 of container 700. First bottom major flap 102 is rotated about a fold line at bottom edge 72 such that first bottom major flap 102 is coupled in a substantially face-to-face relationship against inner layer 752 of bottom 750, first bottom major flap 102 defining intermediate layer 754 of the bottom 750. Second bottom major flap 202 is rotated about a fold line at bottom edge 76 such that second bottom major flap 202 is coupled in a substantially face-to-face relationship against intermediate layer 754 of bottom 750, second bottom major flap 202 defining outer layer 756 of bottom 750.

Top minor tabs 302, 304, 306, 308, 502, 504 are rotated about respective fold lines at top edges 83, 85, 87, 89, 84, 88 such the plurality of top minor tabs 302, 304, 306, 308, 502, 504 are substantially coplanar in top plane 802 substantially perpendicular to the plurality of side walls 722, 724, 726, 728, 730, 732, 734, 736, the plurality of top minor tabs 302, 304, 306, 308, 502, 504 defining inner layer 762 of top 760 of the container 700. First top major flap 152 is rotated about a fold line at top edge 82 such that first top major flap 152 is coupled in a substantially face-to-face relationship against inner layer 762 of top 760, first top major flap 152 defining intermediate layer 764 of top 760. Second top major flap 252 is rotated about a fold line at top edge 86 such that second top major flap 252 is coupled in a substantially face-to-face relationship against intermediate layer 764 of top 760, second top major flap 252 defining outer layer 756 of top 760.

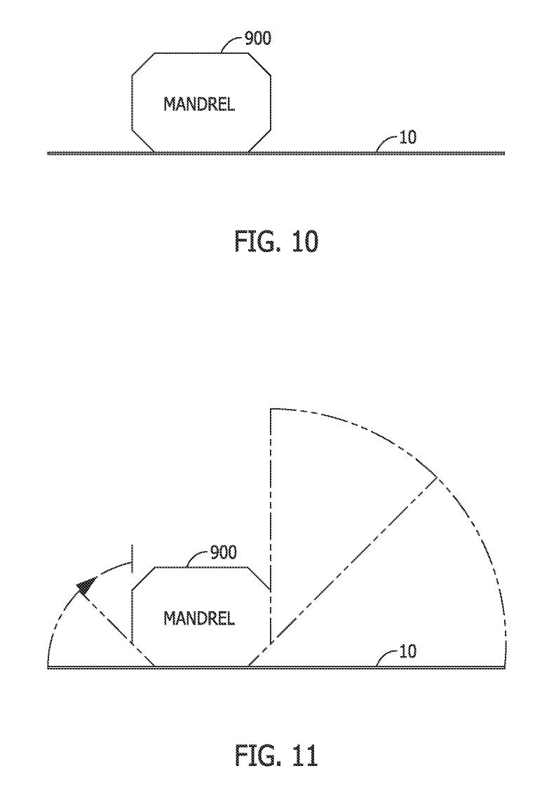

FIGS. 10-13 generally illustrate a method of forming a container 700 from blank 10 using a machine (not shown). The machine includes hot melt glue guns that apply an adhesive 680 to blank 10 in the configuration shown generally in FIG. 1. Adhesive 680 is applied to interior surface 12 of first bottom major flap 102, second bottom major flap 202, first top major flap 152, and second top major flap 252. In some embodiments, adhesive 680 may be applied in a different configuration. For example, adhesive 680 may only be applied to bottom major flaps 102, 202 such that top 760 of container 700 will be left open for later assembly.

The machine further includes a mandrel 900 defined by a plurality of wide walls substantially circumscribing an axis extending through the center of mandrel 900. FIGS. 10-13 show that mandrel 900 has an external shape that is complementary to at least a portion of an internal shape of container 700 formed from blank 10.

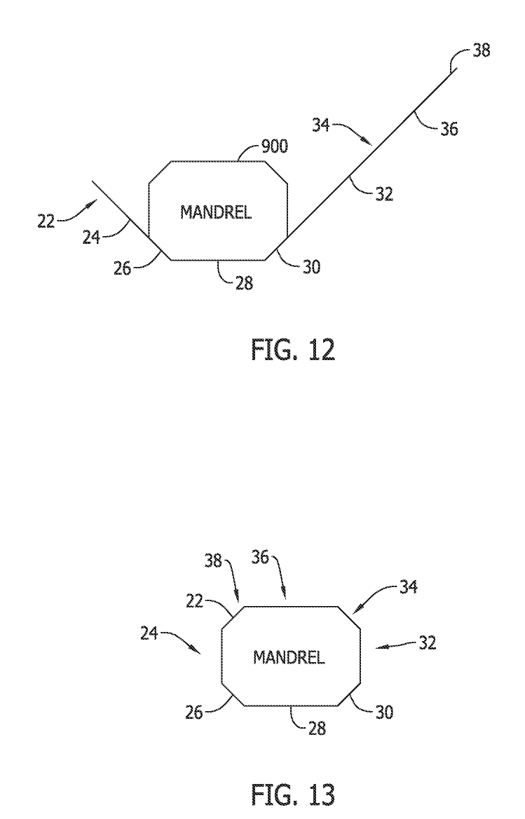

FIG. 10 generally illustrates the position of blank 10 with respect to mandrel 900 after a member (not shown) engages first major panel 24. As shown in FIGS. 11-13, another member (not shown) of the machine engages panels 22, 24, 26, 30, 32, 34, 36, 38 and wraps the panels around mandrel 900. FIGS. 12 and 13 generally illustrate blank 10 as wrapped around mandrel 900.

Also shown in FIG. 13, end panels 22, 38 overlap and are pressed tightly against mandrel 900. In one embodiment, end panel 38 overlaps end panel 22 and is pressed tightly against mandrel 900. In another embodiment, end panel 22 overlaps end panel 38 and is pressed tightly against mandrel 900.

The machine used to form container 700 from blank 10 also includes at least one folder element and at least one bottom presser element for forming bottom 750 of container 700. Various flap folding elements fold bottom corner flaps 402, 404, 406, 408 tightly against mandrel 900. Various flap folding elements further fold bottom minor flaps 602, 604 tightly against mandrel 900 such that bottom minor tabs 402, 404, 406, 408, 602, 604 are coplanar in plane 800 to define inner layer 752 of bottom 750. First bottom major flap 102 is folded tight and secured to inner layer 752 using a sealing mechanism. Second bottom major flap 202 is folded tight and secured to first bottom major flap 102 using a sealing mechanism. Container 700 is formed except for top 760. Container 700 can then be ejected from mandrel 900. Top 760 can be subsequently assembled by folding top minor tabs 302, 304, 306, 308, 502, 504, first top major flap 152, and second top major flap 252 in the same fashion as respective bottom minor tabs 402, 404, 406, 408, 602, 604, first bottom major flap 102, and second bottom major flap 202.

Exemplary embodiments of blanks, containers, and methods, are described and/or illustrated herein in detail. The blanks, containers, and methods are not limited to the specific embodiments described herein, but rather, elements of each blank and container and steps of each method may be utilized independently and separately from other elements and steps described herein. Each blank and container element and each method step can also be used in combination with other blank and container elements and/or method steps.

When introducing elements, components, etc. of the methods and assemblies described and/or illustrated herein, the articles “a”, “an”, “the” and “said” are intended to mean that there are one or more of the element(s), component(s), etc. The terms “comprising”, “including” and “having” are intended to be inclusive and mean that there may be additional element(s), component(s), etc. other than the listed element(s), component(s), etc.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blank for constructing a container, the blank comprising:
a plurality of side panels coupled together in a series along substantially parallel fold lines, the plurality of side panels comprising at least a first minor panel and a first intermediate panel extending from a side edge of the first minor panel;
a first bottom corner flap extending from a bottom edge of the first intermediate panel, wherein the first bottom corner flap includes a free edge comprising a first portion; and
a first bottom minor flap extending from a bottom edge of the first minor panel, wherein the first bottom minor flap includes a free edge comprising a first portion,
wherein the first portion of the free edge of the first bottom corner flap engages the first portion of the free edge of the first bottom minor flap in an edge-to-edge relationship when the container is formed from the blank.

2. The blank of claim 1, wherein the plurality of side panels further comprises a second intermediate panel extending from the first minor panel opposite the first intermediate panel, the blank further comprising a second bottom corner flap extending from a bottom edge of the second intermediate panel, wherein the second bottom corner flap includes a free edge comprising a first portion,
wherein the free edge of the first bottom minor flap further comprises a second portion opposite the first portion, and
wherein the first portion of the free edge of the second bottom corner flap engages the second portion of the free edge of the first bottom minor flap in an edge-to-edge relationship when the container is formed from the blank.

3. The blank of claim 1, wherein the plurality of side panels further comprises a first major panel extending from a side edge of the first intermediate panel opposite the first minor panel, said blank further comprising a first bottom major flap extending from a bottom edge of the first major panel,
wherein the first bottom corner flap and the first bottom minor flap at least partially define an inner layer of a bottom of the container, when the container is formed from the blank, and
wherein the first bottom major flap is configured to overlay the inner layer when the container is formed from the blank, the first bottom major flap defining an intermediate layer of the bottom of the container.

4. The blank of claim 3, wherein the first minor panel and the first intermediate panel have a first length, and wherein the first major panel has a second length that is longer than the first length by about twice a thickness of the blank, the first bottom major flap being configured to overlay the inner layer and maintain the inner layer in a planar orientation.

5. The blank of claim 3, wherein the plurality of side panels further comprises a second intermediate panel extending from the first minor panel opposite the first intermediate panel, and a second major panel extending from the second intermediate panel opposite the first minor panel, said blank further comprising a second bottom major flap extending from a bottom edge of the second major panel, wherein the second bottom major flap is configured to overlay the intermediate layer when the container is formed from the blank, the second bottom major flap defining an outer layer of the bottom of the container.

6. The blank of claim 5, wherein the first minor panel and the first intermediate panel have a first length, and wherein the first major panel has a second length that is longer than the first length by about twice a thickness of the blank, the first bottom major flap being configured to overlay the inner layer and maintain the inner layer in a planar orientation, and
wherein the second major panel has a third length that is longer than the second length by about twice the thickness of the blank, the second major bottom flap being configured to overlay the intermediate layer and maintain the intermediate layer in a planar orientation.

7. The blank of claim 1, wherein the first minor panel comprises an access tab having a perimeter defined by a fold line at a top edge of the first minor panel, opposing side edges of the first minor panel, and a bottom edge defined through the first minor panel from a first side edge of the access tab to a second side edge of the access tab, and wherein the first side edge, the second side edge, and the bottom edge of the access tab comprise lines of weakness, such that exerting a force on the access tab decouples the access tab from the first minor panel along the first side edge, the second side edge, and the bottom edge.

8. The blank of claim 7, wherein the access tab comprises a punch-out tab having a perimeter defined by the bottom edge of the access tab, opposing side edges extending from the bottom edge into the access tab, and a fold line extending between a first side edge of the opposing side edges of the punch-out tab and a second side edge of the opposing side edges of the punch-out tab, wherein the first side edge, the second side edge, and the bottom edge of the punch-out tab comprise lines of weakness, such that exerting a force on an exterior surface of the punch-out tab decouples the punch-out tab from the access tab along the first side edge, the second side edge, and the bottom edge of the punch-out tab, enabling access to an interior surface of the access tab through an opening defined by the perimeter of the punch-out tab.

9. The blank of claim 1, further comprising:
a first top corner flap extending from a top edge of the first intermediate panel, wherein the first top corner flap includes a free edge comprising a first portion; and
a first top minor flap extending from a top edge of the first minor panel, wherein the first top minor flap includes a free edge comprising a first portion,
wherein the first portion of the free edge of the first top corner flap engages the first portion of the free edge of the first top minor flap in an edge-to-edge relationship when the container is formed from the blank, the first top corner flap and the first top minor flap defining an inner layer of a top of the container.

10. A sift-resistant container comprising:
a first side wall;
a second side wall extending from a side edge of the first side wall; and
a bottom wall comprising:
a first bottom corner flap extending from a bottom edge of the first side wall, the first bottom corner flap including a free edge including a first portion, and
a first bottom minor flap extending from a bottom edge of the second side wall, the first bottom minor flap including a free edge including a first portion,
wherein the first portion of the free edge of the first bottom corner flap engages the first portion of the free edge of the first bottom minor flap in an edge-to-edge relationship.

11. The sift-resistant container of claim 10, further comprising a third side wall extending from a side edge of the second side wall opposite the first wall,
wherein the bottom wall further comprises a second bottom corner flap extending from a bottom edge of the third side wall, the second bottom corner flap including a free edge including a first portion,
wherein the free edge of the first bottom minor flap further includes a second portion opposite the first portion, and
wherein the first portion of the free edge of the second bottom corner flap engages the second portion of the free edge of the first bottom minor flap in an edge-to-edge relationship.

12. The sift-resistant container of claim 11, wherein the first bottom corner flap, the first bottom minor flap, and the second bottom corner flap define a planar inner layer of the bottom wall having an area extending from a first corner of the first side wall and a first corner of the third side wall to the bottom edges of the first, second, and third side walls.

13. The sift-resistant container of claim 10, further comprising a third side wall extending from a side edge of the first wall opposite the second side wall, wherein the first bottom corner flap and the first bottom minor flap define an inner layer of the bottom wall, and wherein the bottom wall further comprises an intermediate layer coupled in a face-to-face relationship with an exterior surface of the inner layer, the intermediate layer including a first bottom major flap extending from a bottom edge of the third side wall.

14. The sift-resistant container of claim 13, further comprising:
a fourth side wall extending from a side edge of the second wall opposite the first side wall; and
a fifth side wall extending from a side edge of the fourth side wall opposite the third side wall, the fifth side wall opposing the third side wall of the container,
wherein the bottom wall further comprises an outer layer coupled in a face-to-face relationship with an exterior surface of the intermediate layer, the outer layer including a second bottom major flap extending from a bottom edge of the fifth side wall.

15. The sift-resistant container of claim 10, wherein the second wall comprises an access tab, wherein opposing side edges and a bottom edge of the access tab comprise lines of weakness, such that exerting a force on the access tab decouples the access tab from the first side wall, enabling access to a cavity of the container partially defined by the first side wall, the second side wall, and the bottom wall, and wherein the access tab comprises a punch-out tab having a perimeter defined by the bottom edge of the access tab, opposing side edges extending from the bottom edge into the access tab, and a fold line, wherein the side edges and the bottom edge of the punch-out tab comprise lines of weakness, such that exerting a force on an exterior surface of the punch-out tab decouples the punch-out tab from the access tab, enabling access to an interior surface of the access tab through an opening defined by the perimeter of the punch-out tab.

16. The sift-resistant container of claim 10, further comprising a top wall, the top wall comprising:
a first top corner flap extending from a top edge of the first side wall, the first top corner flap including a free edge including a first portion, and
a first top minor flap extending from a top edge of the second side wall, the first top minor flap including a free edge including a first portion,
wherein the first portion of the free edge of the first top corner flap engages the first portion of the first top minor flap in an edge-to-edge relationship.

17. A method for forming a sift-resistant container from a blank, the blank including a plurality of side panels coupled together in a series along substantially parallel fold lines, the plurality of side panels including at least a first minor panel and a first intermediate panel extending from a side edge of the first minor panel, the blank further including a first bottom corner flap extending from a bottom edge of the first intermediate panel and a first bottom minor flap extending from a bottom edge of the first minor panel, wherein the first bottom corner flap includes a free edge including a first portion and the first bottom minor flap includes a free edge including a first portion, said method comprising:
rotating the plurality of side panels about the plurality of fold lines to form a plurality of side walls of the container, the plurality of side walls defining a cavity;
rotating the first bottom corner flap inwardly towards the cavity into a substantially perpendicular relationship with the plurality of side walls; and
rotating the first bottom minor flap inwardly towards the cavity into a substantially perpendicular relationship with the plurality of side walls, said rotating engaging the first portion of the free edge of the first bottom corner flap with the first portion of the free edge of the first bottom minor flap in an edge-to-edge relationship.

18. The method of claim 17, wherein the first bottom corner panel and the first bottom minor panel define an inner layer of a bottom of the container, wherein the plurality of side panels of the blank further includes a first major panel, the blank further including a first bottom major flap extending from a bottom edge of the first major panel, said method further comprising:
rotating the first bottom major flap inwardly towards the cavity into a substantially face-to-face relationship with the inner layer of the bottom of the container, the first bottom major flap defining an intermediate layer of the bottom of the container; and
securing the first bottom major flap to the inner layer.

19. The method of claim 18, the plurality of side panels further including a second intermediate panel extending from a side edge of the first minor panel opposite the first intermediate panel and a second major panel extending from a side edge of the second intermediate panel opposite the first minor panel, the blank further including a second bottom major flap extending from a bottom edge of the second major panel, said method further comprising:
rotating the second bottom major flap inwardly towards the cavity into a substantially face-to-face relationship with the intermediate layer of the bottom of the container, the second bottom major flap defining an outer layer of the bottom of the container; and
securing the second bottom major flap to the intermediate layer.

20. The method of claim 19, the blank further comprising a first top corner flap extending from a top edge of the first intermediate panel, a first top corner flap extending from a top edge of the first minor panel, a first top major flap extending from a top edge of the first major panel, and a second top major flap extending from a top edge of the second major panel, said method further comprising:
rotating the first top corner flap inwardly towards the cavity into a substantially perpendicular relationship with the plurality of side walls; and
rotating the first top minor flap inwardly towards the cavity into a substantially perpendicular relationship with the plurality of side walls, said rotating aligning the first top minor flap in a coplanar relationship with the first top corner flap, the first top minor flap and the first top corner flap defining an inner layer of a top of the container;
rotating the first top major flap inwardly towards the cavity into a substantially face-to-face relationship with the inner layer of the top of the container, the first top major flap defining an intermediate layer of the top of the container;
securing the first top major flap to the inner layer of the top of the container;
rotating the second top major flap inwardly towards the cavity into a substantially face-to-face relationship with the intermediate layer of the top of the container, the second top major flap defining an outer layer of the top of the container; and
securing the second top major flap to the intermediate layer of the top of the container.
